(19) United States
(12) Patent Application Publication
(10) Pub. No.: US 2017/0276524 A1
(43) Pub. Date: Sep. 28, 2017

(54) FLOW RATE DETECTING DEVICE

(71) Applicant: SEIKO EPSON CORPORATION, Tokyo (JP)

(72) Inventors: Shuji OTSUKA, Shiojiri (JP); Kazumi ARUGA, Fujimi (JP); Hidenori USUDA, Matsumoto (JP); Seiichi TANIGUCHI, Asahi (JP)

(21) Appl. No.: 15/462,187

(22) Filed: Mar. 17, 2017

(30) Foreign Application Priority Data
Mar. 24, 2016 (JP) 2016-059678

(51) Int. Cl. G01F 1/684

(52) U.S. Cl. CPC G01F 1/684

(57) ABSTRACT

A flow rate detecting device according to an aspect of the invention includes a pipe which includes a bent portion and through which fluid is passed; two temperature detecting portions which detect the temperature of the fluid in the pipe; and a temperature changing portion which changes the temperature of the fluid in the pipe at an intermediate position in which distances between each of the two temperature detecting portions and the intermediate position are equidistant. The intermediate position is positioned in the bent portion in the pipe, and the bent portion is formed to be line symmetric with respect to a straight line passing through the intermediate position.

### BACKGROUND

1. Technical Field

The present invention relates to a flow rate detecting device.

2. Related Art

In a flow rate detecting device of the related art, a method of measuring a difference in temperature of fluid flowing in an inside of a pipe and then detecting a flow rate from the difference in temperature is known.

A flow rate detecting device which is provided with respect to a pipe through which fluid flows and obtains a flow rate of a flowing fluid based on outputs of a first temperature detecting means and a second temperature detecting means is disclosed in JP-A-8-338746.

However, since the first temperature detection means and the second temperature detection means which detect the temperature are provided to be spaced apart from each other, the flow rate detecting device of JP-A-8-338746 is susceptible to environmental change in each position in which the first temperature detection means and the second temperature detection means are provided, for example, the influence of the difference in temperature around the two temperature detection means. Therefore, the difference in temperature of the fluid flowing in an inside of the pipe cannot be accurately measured, and thus there is a problem that the flow rate detection accuracy is lowered.

### SUMMARY

The invention can be realized in the following aspects or application examples.

### Application Example 1

According to the application example, there is provided a flow rate detecting device including a pipe which includes a bent portion and through which fluid is passed; two temperature detecting portions which detect the temperature of the fluid in the pipe; and a temperature changing portion which changes the temperature of the fluid in the pipe at an intermediate position in which distances between each of the two temperature detecting portions and the intermediate position are equidistant. In the pipe, the intermediate position is positioned in the bent portion and the bent portion is formed to be line symmetric with respect to a straight line passing through the intermediate position.

According to the application example, since the pipe through which the fluid flows has the bent portion which is bent at the intermediate position as an apex, the two temperature detecting portions which detect the temperature of the fluid can be disposed to be close to each other, as compared with a case where the two temperature detecting portions are disposed in a straight pipe. Therefore, difference in environmental change between the two temperature detecting portions can be reduced and the temperature of fluid at the position on which the two temperature detecting devices are disposed can be accurately measured. Therefore, the flow rate detecting device which accurately detects the flow rate of the fluid flowing in an inside of the pipe can be obtained.

### Application Example 2

In the flow rate detecting device according to the application example, it is preferable that the bent portion have a U shape.

According to the application example, since the bent portion has the U shape and the two temperature detecting portions can be disposed on the positions which are closer to each other, the difference in environmental change between the two temperature detecting portions can be further reduced and the temperature of the fluid can be further accurately measured.

### Application Example 3

It is preferable that the flow rate detecting device according to the application example further include a shielding portion and at least a portion of the pipe and the two temperature detecting portions be covered by the shielding portion.

According to the application example, since the portion of the pipe and the two temperature detecting portions are covered by the shielding portion, the environmental change in an outside of the shielding portion can be prevented from being transferred to the portion of the pipe and the two temperature detecting portions and thus the temperature of the fluid in the two temperature detecting portions can be accurately measured.

### Application Example 4

In the flow rate detecting device according to the application example, it is preferable that the shielding portion shield electromagnetic waves.

According to this application example, since the shielding portion shields electromagnetic waves, heat as the electromagnetic waves can be prevented from being transferred from an outside portion of the shielding portion to the portion of the pipe disposed in an inside of the shielding portion and the two temperature detecting portions.

### Application Example 5

In the flow rate detecting device according to the application example, it is preferable that the shielding portion shield heat.

According to this application example, since the shielding portion shields heat, heat is prevented from being transferred from the outside portion of the shielding portion to the portion of the pipe disposed in the inside of the shielding portion and the two temperature detecting portions.

### Application Example 6

In the flow rate detecting device according to the application example, it is preferable that the temperature changing portion heat the fluid.

According to this application example, a difference in temperature in the fluid can be generated at the two temperature detecting portions according to the flow rate of the fluid flowing in the inside of the pipe, by the fluid being heated in the temperature changing portion. Therefore, the flow rate of the fluid flowing in the inside of the pipe can be detected, by this difference in temperature being measured.

### Application Example 7

In the flow rate detecting device according to the application example, it is preferable that the temperature changing portion cool the fluid.

According to this application example, a difference in temperature can be generated in the fluid in the two temperature detecting portions according to the flow rate of the fluid flowing in the inside of the pipe, by the fluid being cooled in the temperature changing portion. Therefore, the flow rate of the fluid flowing in the pipe can be detected, by this difference in temperature being measured.

### Application Example 8

In the flow rate detecting device according to the application example, it is preferable that the temperature detecting portions detect the temperature of the fluid without contact.

According to this application example, since the temperature of the fluid is detected without contact, the influence of the temperature detecting portions is unlikely to be transferred to the fluid, and deterioration of the accuracy of temperature measurement of the fluid can be reduced.

### Application Example 9

In the flow rate detecting device according to the application example, it is preferable that the pipe have infrared transmittance.

According to this application example, since the pipe has the infrared transmittance, the temperature of the fluid can be measured by the temperature detecting portions in the outside of the pipe by the temperature of the fluid being transmitted through the pipe as infrared rays.

### Application Example 10

In the flow rate detecting device according to the application example, it is preferable that the pipe have heat conductivity lower than that of the fluid.

According to this application example, since the influence of the heat conduction of the pipe on the fluid and the temperature detecting portions can be prevented at the temperature detecting position, the temperature which is conducted through the fluid and is detected can be accurately measured in the temperature detecting portions.

### BRIEF DESCRIPTION OF THE DRAWINGS

The invention will be described with reference to the accompanying drawings, wherein like numbers reference like elements.

FIG. 1 is a side view illustrating a configuration of a flow rate detecting device according to a first embodiment of the invention.

FIG. 2 is a cross-sectional view taken along line II-II in FIG. 1.

FIG. 3 is a diagram for explaining a relationship between elapsed time and temperature of fluid.

FIG. 4 is a plan view illustrating a configuration of a flow rate detecting device according to a second embodiment of the invention.

FIG. 5 is a plan view illustrating a configuration of a flow rate detecting device according to a third embodiment of the invention.

FIG. 6 is a schematic view illustrating a configuration of a recording device including the flow rate detecting device according to the embodiments.

### DESCRIPTION OF EXEMPLARY EMBODIMENTS

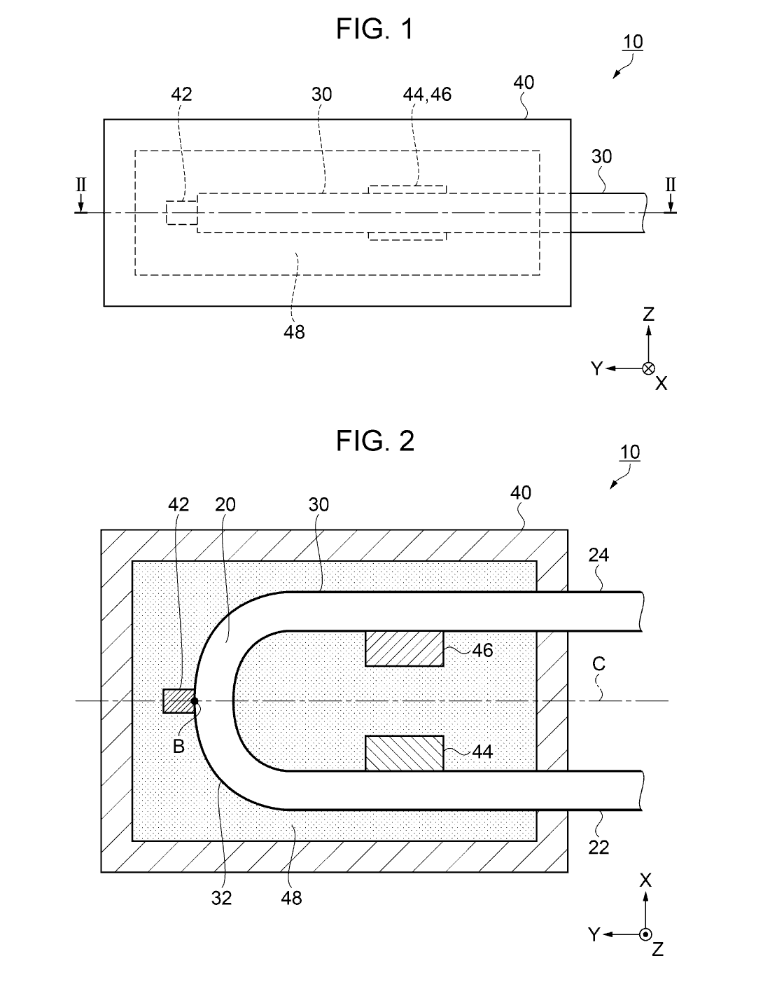

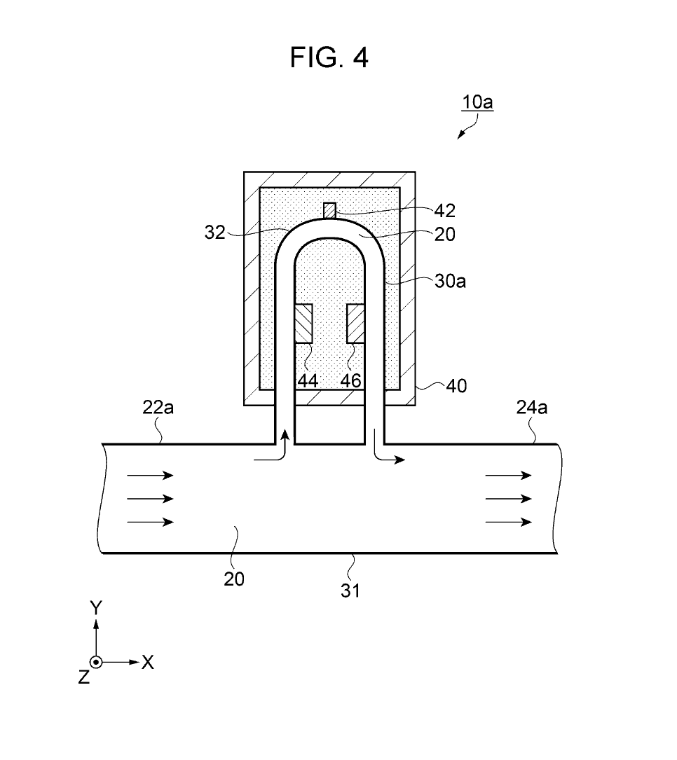

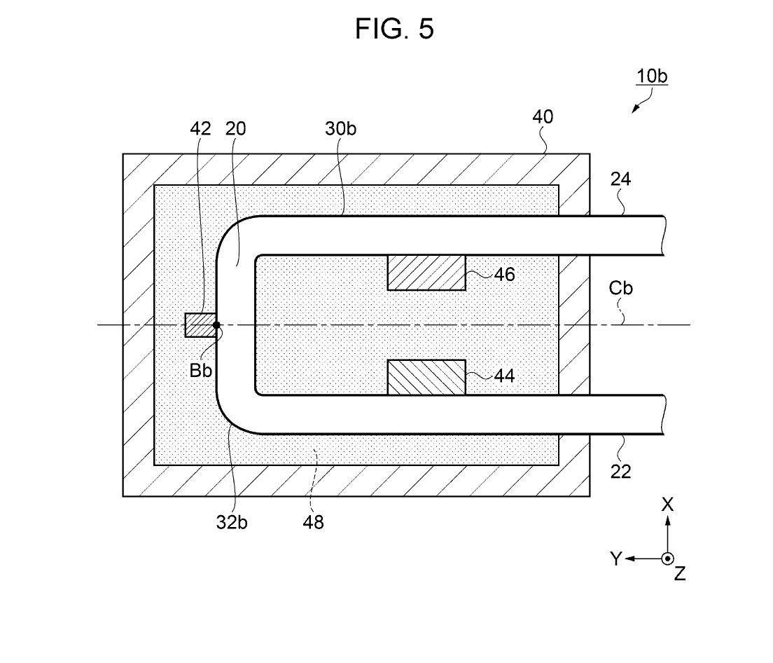

Hereinafter, with reference to the drawings, embodiments of the invention will be described in detail. In each of the drawings illustrated below, in order to make the respective components to be easily recognized on the drawings, there is a case where the dimension and ratio of each component are illustrated differently from those of the actual components. In addition, in FIG. 1, FIG. 2, FIG. 4, and FIG. 5, the X axis, the Y axis, and the Z axis are illustrated as three axes which are perpendicular to each other for convenience of description, and in the following description, a direction which is parallel to the X axis and Y axis is referred to as a “horizontal direction”, and a direction which is parallel to the Z axis is referred to as a “vertical direction”.

### Flow Rate Detecting Device

### First Embodiment

First, with reference to FIG. 1 and FIG. 2, a flow rate detecting device 10 according to a first embodiment 1 of the invention will be described.

FIG. 1 is a side view illustrating a configuration of a flow rate detecting device according to a first embodiment of the invention. FIG. 2 is a cross-sectional view taken along line II-II in FIG. 1.

As illustrated in FIG. 1 and FIG. 2, the flow rate detecting device 10 of the embodiment includes a pipe 30 through which fluid 20 passes, two temperature detecting portions 44 and 46 for detecting the temperature of the fluid 20 in the pipe 30, a temperature changing portion 42 for changing the temperature of the fluid 20, and a shielding portion 40 for covering a portion of the pipe 30 and the two temperature detecting portions 44 and 46.

The pipe 30 has a bent portion 32 which is a folded portion of the pipe 30 and extends in a straight line shape respectively from both ends of the bent portion 32 along a horizontal direction of the Y axis. In addition, the fluid 20 which is capable of flowing from an upstream portion 22 of the pipe 30 passes through the bent portion 32 and flows to an downstream portion 24. In the embodiment, with respect to a shape of the bent portion 32, a U shape will be mainly described.

The bent portion 32 has an intermediate position B at which the distances between each of the two temperature detecting portions 44 and 46 and the intermediate position B are equidistant and is shaped so as to be line symmetric with respect to the straight line C passing through the intermediate position B. A straight pipe 30 which is positioned on an upstream side of the bent portion 32 and a straight pipe 30 which is positioned on a downstream side of the bent portion 32 are disposed to be arranged in the horizontal direction of the X axis. Therefore, the influence of gravity and convection received by the fluid 20 flowing in the pipe 30 can be reduced.

As material constituting the pipe 30, transparent glass or plastic is used. Since the glass and the plastic are likely to bend into a U shape or the like by heat being applied and have infrared transmittance, it is preferable that the temperature of the fluid 20 in the inside of the pipe 30 be measured from the outside portion of the pipe 30 as heat radiation infrared rays.

In addition, since, as the plastic, for example, polyethylene, polypropylene, polyvinyl chloride, or the like has a heat conductivity lower than that of water which becomes the fluid 20 for example, it is possible to reduce the fact that heat is conducted through the pipe 30 faster than through the fluid 20 and then reaches an temperature detecting position at which the temperature detecting portions 44 and 46 detect the temperature. Therefore, the influence on the fluid 20 and the temperature detecting portions 44 and 46 at the temperature detecting position can be suppressed by the heat being conducted through the pipe 30, and thus temperature which is detected by the fluid 20 being conducted can be accurately measured in the temperature detecting portions 44 and 46.

In the two temperature detecting portions 44 and 46, the temperature detecting portion 44 which is disposed in the straight pipe 30 on the upstream side and the temperature detecting portion 46 which is provided in the straight pipe 30 on the downstream side are disposed on positions at which the distances between each of the temperature detecting portions 44 and 46 and the intermediate position B of the bent portion 32 are equidistant. In addition, the two temperature detecting portions 44 and 46 are disposed between the straight pipe 30 on the upstream side and the straight pipe 30 on the downstream side. Therefore, the two temperature detecting portions 44 and 46 can be disposed at positions which are close to each other, and thus the difference in environmental change between the two temperature detecting portions 44 and 46 can be reduced.

A thermopile, a thermistor, a silicon diode thermometer, a platinum resistance thermometer, or the like is used as the temperature detecting portions 44 and 46. The thermopile uses a seebeck effect in which the difference in temperature of objects is converted into a voltage and outputs a voltage proportional to the difference in temperature or the temperature gradient between the hot junction side to which the infrared absorption film is attached and the cold junction side which compares with the hot junction side and thus can measure the temperature of the fluid 20 without contact, as the heat radiation infrared rays. Therefore, for example, the influence of heat or the like possessed by the temperature detecting portions 44 and 46 is unlikely to be transferred to the fluid 20, and the deterioration of the temperature measurement accuracy of the fluid 20 can be reduced. In addition, the difference in environmental change on the cold junction side of the thermopile which is used for the temperature detecting portions 44 and 46 can be reduced, and the measurement accuracy of the temperature of the fluid 20 is further improved, by the two temperature detecting portions 44 and 46 being disposed to be close to each other. Therefore, the thermopile is suitable for the temperature detecting portions 44 and 46.

The temperature changing portion 42 is disposed to be in contact with the intermediate position B of the bent portion 32 of the pipe 30. By the temperature changing portion 42 being located at the intermediate position B, in a state where the fluid 20 does not flow, with respect to the position on which the two temperature detecting portions 44 and 46 are disposed, the same heat can be conducted through the fluid 20 at the same time. In addition, the temperature changing portion 42 may heat or cool the fluid 20 in the inside of the pipe 30. In other words, it is sufficient that the temperature change of the fluid 20 generated at the intermediate position B may be transferred to the position on which the two temperature detecting portions 44 and 46 are disposed.

As the temperature changing portion 42, a heater, a peltier element, or the like is preferable. In the case of the peltier element, when the fluid 20 is heated, a side of the peltier element which generates heat is disposed to be in close contact with the intermediate position B in the bent portion 32 of the pipe 30 and when the fluid 20 is cooled, a side of the peltier element which sucks heat is disposed in close contact with the intermediate position B in the bent portion 32 of the pipe 30.

The shielding portion 40 covers the temperature changing portion 42, the bent portion 32 of the pipe 30, the two temperature detecting portions 44 and 46, and the straight pipe 30 on which the two temperature detecting portions 44 and 46 are disposed.

In addition, a heat insulating member 48 for covering a temperature changing portion 42, a temperature detecting portions 44 and 46 and a portion of the pipe 30 is provided in the inside of the shielding portion 40, and thus release of heat to the outside of the temperature changing portion 42, the temperature detecting portions 44 and 46, and the fluid 20 in the inside of the pipe 30 and the like or the influence of the temperature from the outside to the temperature changing portion 42, the temperature detecting portions 44 and 46, the fluid 20 in the inside of the pipe 30, and the like are prevented.

In the embodiment, although the shielding portion 40 covers the temperature changing portion 42 and the bent portion 32 of the pipe 30, the invention is not limited to this, and the shielding portion 40 also may cover the two temperature detecting portions 44 and 46 and a portion of the straight pipe 30 on which the two temperature detection portions 44 and 46 are disposed.

As material constituting the shielding portion 40, any material may be used as long as the outside portion of the shielding portion 40 is unlikely to influence the covered inner portion member.

In addition, as the heat insulating member 48, glass wool, hard urethane, or the like is preferable. Although the heat insulating member 48 is used in the inside of the shielding portion 40 in the embodiment, the invention is not limited to this, and the inside portion of the shielding portion 40 may be also configured to be as a reduced pressure state.

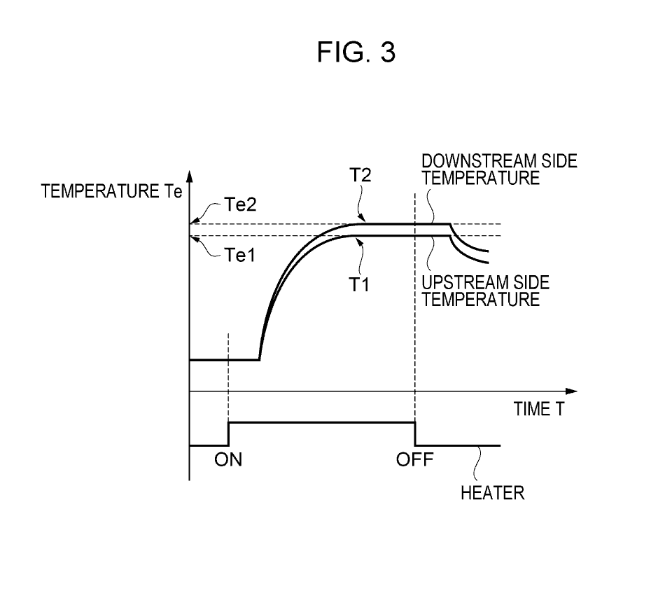

Next, with reference to FIG. 3, a method of detecting a flow rate of the fluid 20 by the flow rate detecting device 10 of the embodiment will be described. FIG. 3 is a diagram for explaining the relationship between the elapsed time and the temperature of the fluid. In the following description, a case where the flow rate is detected by heating the fluid 20 will be described.

As illustrated in FIG. 3, when the heater serving as the temperature changing portion 42 is turned on and the fluid 20 in the inside of the pipe 30 is heated at a predetermined temperature, the temperature of the fluid 20 at the temperature detecting position in which the two temperature detecting portions 44 and 46 detect the temperature begins to rise respectively after time during which the heat is conducted through the fluid 20 and reaches the temperature detecting position from the intermediate position B has lapsed. In a case where the fluid 20 does not flows, it is preferable that the time during which the heat is conducted through the fluid 20 and then reaches the temperature detecting positions of the two temperature detecting portions 44 and 46 from the intermediate position B be adjusted to be same at an each position of the two temperature detecting portions 44 and 46.

Thereafter, the temperature of the fluid 20 in the disposition position of the temperature detecting portion 44 which is in the upstream side reaches a temperature Te1 at which it is saturated at time T1. In addition, the temperature of the fluid 20 in the disposition position of the temperature detecting portion 46 which is in the downstream side reaches a temperature Te2 at which it is saturated at time T2. Thereafter, when the heater is turned off, the temperature of the fluid 20 in the disposition position of the two temperature detecting portions 44 and 46 is maintained at the temperatures Te1 and Te2 at which it is saturated, and thereafter heat dissipation starts and gradually reduced respectively since heat is not supplied.

Here, the temperatures Te1 and Te2 in the upstream side temperature and the downstream side temperature at which it is saturated differ from each other in the temperature of the fluid 20 at the temperature detecting position in which the two temperature detecting portions 44 and 46 detect the temperature. This is because heat is more likely to be transferred from a side of the temperature detecting position of the downstream of the temperature changing portion 42 than the temperature detecting position of the upstream of the temperature changing portion 42. In other words, in a case where the fluid 20 flows from the upstream to the downstream in the inside of the pipe 30, the heat of the temperature changing portion 42 not only is conducted through the fluid 20 but also the amount of heat moving together with the fluid 20 is added along with the flow of the heated fluid 20 at the temperature detecting position of the downstream of the temperature changing portion 42. Accordingly, since there is inflow of the unheated fluid 20 at the temperature detecting position of the upstream of the temperature changing portion 42, the amount of heat conducted from the temperature changing portion 42 is deprived by the inflowing fluid 20 and thus is reduced. Therefore, the temperature Te1 of the upstream side temperature at which it is saturated becomes lower than the temperature Te2 of the downstream side temperature at which it is saturated.

In addition, in a case where the flow rate of the fluid 20 flowing through the inside of the pipe 30 is increased, the amount of heat which is deprived by the inflowing fluid 20 at the temperature detecting position of the upstream side increases, and the temperature Te1 of the upstream side temperature at which it is saturated is further decreased. Accordingly, since the difference in temperature between the temperature Te1 of the upstream temperature at which it is saturated and the temperature Te2 of the downstream temperature at which it is saturated and the flow rate of the fluid 20 flowing through the inside of the pipe 30 are in a proportional relation with each other, the flow rate of the fluid 20 flowing through the inside of the pipe 30 can be detected by the difference in temperature between the temperature Te1 and the temperature Te2 being measured. In a case where the temperature Te2 is detected to be lower than the temperature Te1, it is determined that the fluid 20 is flowing backward in the inside of the pipe 30. However, a relationship between the difference in temperature between the temperature Te1 and the temperature Te2 and the flow rate of the fluid 20 is the same as a case where the fluid 20 flows from upstream toward downstream.

As described above, according to the flow rate detecting device 10 of the embodiment, the following effects can be obtained.

Since the pipe 30 through which the fluid 20 flows has the bent portion 32 which is bent at the intermediate position B as an apex, the two temperature detecting portions 44 and 46 which detect the temperature of the fluid 20 can be disposed on positions which are close to each other, compared to a case of being disposed in the straight pipe. Therefore, the difference in environmental change between the two temperature detecting portions 44 and 46 can be reduced, and thus the temperature of the fluid 20 at the position in which the two temperature detecting portions 44 and 46 are disposed can be accurately measured. Therefore, the flow rate detecting device 10 which accurately detects the flow rate of the fluid 20 flowing through the inside of the pipe 30 can be obtained.

In addition, since the bent portion 32 has an U shape and the two temperature detecting portions 44 and 46 can be disposed to be closer to each other, the difference in environmental change between the two temperature detecting portions 44 and 46 can be further reduced, and thus the temperature of the fluid 20 can be further accurately measured.

In addition, since a portion of the pipe 30 and the two temperature detecting portions 44 and 46 are covered by the shielding portion 40, transfer of an environmental change in the outside of the shielding portion 40 to a portion of the pipe 30 and the two temperature detecting portions 44 and 46 can be suppressed and thus the temperature of the fluid 20 in the two temperature detecting portions 44 and 46 can be accurately measured.

In addition, since the shielding portion 40 can shield electromagnetic waves and heat, electromagnetic waves and heat from the outside of the shielding portion 40 to a portion of the pipe 30 and the two temperature detecting portions 44 and 46 disposed in the inside of the shielding portion 40 can be prevented from being transferred to the inside portion of the shielding portion 40.

In addition, a difference in temperature can be generated in the fluid 20 at the position in which the two temperature detecting portions 44 and 46 are disposed, along with the flow rate of the fluid 20 flowing through the inside of the pipe 30 by the fluid 20 in the temperature changing portion 42 being heated or cooled. Therefore, the flow rate of the fluid 20 flowing through the inside of the pipe 30 can be detected by this difference in temperature being measured.

In addition, since the temperature of the fluid 20 can be measured without contact by the thermopile being used as the temperature detecting portions 44 and 46, the influence of the temperature detecting portions 44 and 46 is unlikely to be transferred to the fluid 20, and thus degradation in accuracy of the temperature measurement of the fluid 20 can be reduced.

In addition, since the pipe 30 has infrared transmittance, the temperature of the fluid 20 can be measured by the temperature detecting portions 44 and 46 in the outside of the pipe 30 by the temperature of the fluid being transmitted through the pipe 30 as heat radiation infrared rays.

In addition, the influence of the heat conduction of the pipe 30 on the fluid 20 and the temperature detecting portions 44 and 46 at the temperature detecting position can be suppressed, and thus the temperature at which the fluid 20 is conducted and detected can be accurately measured in the temperature detecting portions 44 and 46.

The flow state of the fluid 20 can be detected by the difference in the time when the temperature change generated in the fluid 20 by the temperature changing portion 42 reaches the temperature detecting positions of the two temperature detecting portions 44 and 46 from the intermediate position B being detected.

### Second Embodiment

Next, with reference to FIG. 4, a flow rate detecting device 10a according to a second embodiment of the invention will be described.

FIG. 4 is a plan view illustrating a configuration of a flow rate detecting device according to a second embodiment of the invention. The same components as those of the first embodiment are denoted by the same reference numerals, and duplicate explanations are omitted.

As illustrated in FIG. 4, in the flow rate detecting device 10a of the embodiment, the pipe 30a is provided with a bypass pipe 31 having an inner diameter which is greater than that of the pipe 30a in the pipe 30a so as to bypass the upstream side temperature detecting portion 44 and the downstream side temperature detecting portion 46.

The fluid 20 flowing from an upstream portion 22a of the bypass pipe 31 is divided into the pipe 30a in the middle of the flow and the divided fluid 20 is passed through a temperature detecting position on which an upstream side temperature detecting portion 44 is disposed, a temperature changing position on which a temperature changing portion 42 is disposed, and a temperature detecting position on which a downstream side temperature detecting portion 46 is disposed, returns to the bypass pipe 31 again and flows to a downstream portion 24a. Therefore, the flow rate of the fluid 20 flowing through the bypass pipe 31 can be calculated from the ratio between the inner diameter of the pipe 30a and the inner diameter of the bypass pipe 31 by the flow rate of the fluid 20 flowing through the pipe 30a being detected.

With the above configuration, the following effects can be obtained in addition to the effects of the first embodiment.

In the flow rate detecting device 10a according to the embodiment, the flow rate detecting device 10a which accurately detects the flow rate of the fluid 20 flowing through the bypass pipe 31 having the inner diameter which is greater than that of the pipe 30a can be obtained.

### Third Embodiment

Next, with reference to FIG. 5, a flow rate detecting device 10b according to a third embodiment of the invention will be described.

FIG. 5 is a plan view illustrating a configuration of a flow rate detecting device according to a third embodiment of the invention. The same components as those of the first embodiment are denoted by the same reference numerals, and duplicate explanations are omitted.

As illustrated in FIG. 5, in the flow rate detecting device 10b of the embodiment, the pipe 30b has a rectangular bent portion 32b and is extended in a straight line shape from both distal ends of the bent portion 32b along the horizontal direction of the Y axis, respectively. In addition, the bent portion 32b has an intermediate position Bb in which the distances between each of the two temperature detecting portions 44 and 46 and the intermediate position Bb are equidistant and is shaped so as to be line symmetric with respect to the straight line Cb passing through the intermediate position Bb.

With the above configuration, the following effects can be obtained in addition to the effects of the first embodiment.

Since the bent portion 32b has a rectangular shape in the flow rate detecting device 10b according to the embodiment, the length of the bent portion 32b in the X-axis direction can be shortened. Therefore, since the distance between the two temperature detecting portions 44 and 46 can be closer to each other and thus the difference in the environmental change can be further reduced, the temperature of the fluid 20 at the positions in which the two temperature detecting portions 44 and 46 are disposed can be accurately measured. Therefore, the flow rate detecting device 10b which accurately detects the flow rate of the fluid 20 flowing through the inside of the pipe 30b can be obtained.

There is no limitation to the shape of the bent portion, and it may be a curved shape, a flexure shape, or a composite shape thereof which is different from the shape illustrated in the drawing.

### Recording Device

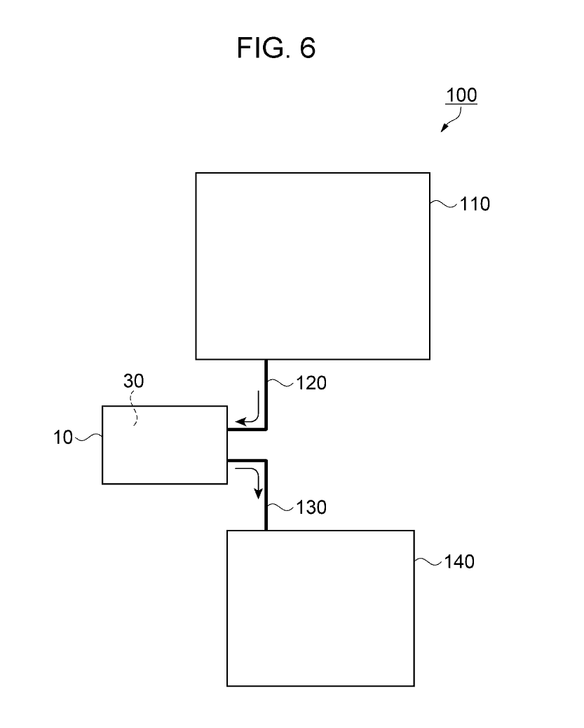

Next, with reference to FIG. 6, a recording device 100 including the flow rate detecting device 10 according to the embodiments will be described.

FIG. 6 is a schematic view illustrating a configuration of a recording device including the flow rate detecting device according to the embodiments.

As illustrated in FIG. 6, the recording device 100 includes an ink supply portion 110, a printing head portion 140, and a flow rate detecting device 10.

The ink supply portion 110 is a cartridge or a tank for storing ink to be supplied to the printing head portion 140.

The printing head portion 140 discharges the supplied ink onto a paper surface and performs printing.

The flow rate detecting device 10 is disposed between the ink supply portion 110 and the printing head portion 140. The ink supply portion 110 and the pipe 30 of the flow rate detecting device 10 are connected by piping 120. In addition, the pipe 30 of the flow rate detecting device 10 and the printing head portion 140 are connected by piping 130. Therefore, the flow rate detecting device 10 can detect the flow rate of the ink supplied from the ink supply portion 110 to the printing head portion 140.

Depending on the size of the inner diameter of the pipe 30 of the flow rate detecting device 10, the flow rate of a small amount of ink can be detected. Therefore, when there is no ink discharge in the printing head portion 140, ink leakage on the flow path from the ink supply portion 110 to the printing head portion 140 can also be detected, by the flow of ink being detected by the flow rate detecting device 10.

As described above, the configuration of each portion of the invention can be replaced by an arbitrary configuration performing the same function as that of the above-described embodiment, and an arbitrary configuration can be also added. In addition, in the invention, arbitrary configurations of the above-described respective embodiment may be combined with each other.

This application claims priority under 35 U.S.C. §119 to Japanese Patent Application No. 2016-059678, filed Mar. 24, 2016. The entire disclosure of Japanese Patent Application No. 2016-059678 is hereby incorporated herein by reference.

What is claimed is:

1. A flow rate detecting device, comprising:
a pipe which includes a bent portion and through which fluid is passed;
two temperature detecting portions which detect the temperature of the fluid in the pipe; and
a temperature changing portion which changes the temperature of the fluid in the pipe at an intermediate position in which distances between each of the two temperature detecting portions and the intermediate position are equidistant,
wherein the intermediate position is positioned in the bent portion in the pipe, and
wherein the bent portion is formed to be line symmetric with respect to a straight line passing through the intermediate position.

2. The flow rate detecting device according to claim 1,
wherein the bent portion has a U shape.

3. The flow rate detecting device according to claim 1, further comprising:
a shielding portion,
wherein at least a portion of the pipe and the two temperature detecting portions are covered by the shielding portion.

4. The flow rate detecting device according to claim 3,
wherein the shielding portion shields electromagnetic waves.

5. The flow rate detecting device according to claim 3,
wherein the shielding portion shields heat.

6. The flow rate detecting device according to claim 1,
wherein the temperature changing portion heats the fluid.

7. The flow rate detecting device according to claim 1,
wherein the temperature changing portion cools the fluid.

8. The flow rate detecting device according to claim 1,
wherein the temperature detecting portions detect the temperature of the fluid without contact.

9. The flow rate detecting device according to claim 1,
wherein the pipe has infrared transmittance.

10. The flow rate detecting device according to claim 1,
wherein the pipe has heat conductivity lower than that of the fluid.
